(19) United States
(12) Patent Application Publication
(10) Pub. No.: US 2007/0018552 A1
(43) Pub. Date: Jan. 25, 2007

(54) Electron emission device, electron emission type backlight unit and flat display apparatus having the same

(75) Inventors: Young-Suk Cho, Suwon-si (KR); Jae-Woo Bae, Suwon-si (KR); Dong-Hyun Kang, Suwon-si (KR); Ik-Chul Lim, Suwon-si (KR); Ui-Song Do, Suwon-si (KR); Kyu-Nam Joo, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/477,472

(22) Filed: Jun. 30, 2006

(30) Foreign Application Priority Data
Jul. 21, 2005 (KR) 2005-66380

(51) Int. Cl. H01J 1/00; H01J 9/02; H01J 19/06

(52) U.S. Cl. 313/311; 313/495; 313/310

(57) ABSTRACT

An electron emission device having improved electron emission efficiency and an electron emission type backlight unit including the electron emission device in which an electric field between an anode electrode and a cathode electrode is effectively blocked, and electrons are emitted continuously and stably by a low gate voltage, thereby improving light-emitting uniformity and light-emitting efficiency. Also provided is a flat display apparatus employing the electron emission type backlight unit having the electron emission device. The electron emission device includes a base substrate; an insulating layer disposed on a surface of the base substrate; a cathode electrode formed on the insulating layer; a gate electrode that is formed on the base substrate, separated from the cathode electrode, and higher than the cathode electrode; and an electron emission layer that is electrically connected to the cathode electrode and disposed to face the gate electrode.

### CROSS-REFERENCE TO RELATED APPLICATIONS

This application claims the benefit of Korean Application No. 2005-66380, filed Jul. 21, 2005, in the Korean Intellectual Property Office, the disclosure of which is incorporated herein by reference.

### BACKGROUND OF THE INVENTION

1. Field of the Invention

Aspects of the present invention relate to an electron emission device, an electron emission type backlight unit, and a flat display apparatus having the same, and more particularly, to an electron emission device with improved electron emission efficiency and light-emitting uniformity, an electron emission type backlight unit employing the electron emission device, and a flat display apparatus having the electron emission type backlight unit.

2. Description of the Related Art

Generally electron emission devices can be classified into electron emission devices using a thermionic cathode and electron emission devices using a cold cathode as an electron emission source. Electron emission devices that use a cold cathode as an electron emission source include field emitter array (FEA) type devices, surface conduction emitter (SCE) type devices, metal insulator metal (MIM) type devices, metal insulator semiconductor (MIS) type devices, ballistic electron surface emitting (BSE) type devices, etc. Aspects of the present invention relate to the FEA type device.

An FEA type electron emission device uses the principle that, when a material having a low work function or a high β function is used as an electron emission source, the material readily emits electrons in a vacuum due to an electric potential. FEA devices that employ a tapered tip structure formed of, for example, Mo, Si as a main component, a carbon group material such as graphite, diamond like carbon (DLC), etc., or a nano structure such as nanotubes, nano wires, etc., have been developed.

FEA type electron emission devices can be classified into top gate types and under gate types according to the arrangement of cathode electrodes and gate electrodes. FEAs can also be classified into two-electrode, three-electrode, or four-electrode type emission devices according to the number of electrodes.

Studies have been conducted into ways of using an electron emission device as a backlight unit of a non-emissive display device.

FIG. 1 illustrates a conventional electron emission type backlight unit 3.

Referring to FIG. 1, the conventional electron emission type backlight unit 3 includes a front panel 1 and an electron emission device 2. The front panel 1 includes a front substrate 90, an anode electrode 80 formed on a lower surface of the front substrate 90, and a phosphor layer 70 coated on the anode electrode 80.

The electron emission device 2 includes a base substrate 10 that faces and is parallel to the front substrate 90, a cathode electrode 20 formed in strips on the base substrate 10, a gate electrode 30 that is formed in strips and is parallel to the cathode electrode 20, and electron emission layers 40 and 50 respectively formed around the cathode electrode 20 and the gate electrode 30. An electron emission gap G is formed between the electron emission layers 40 and 50 surrounding the cathode electrode 20 and the gate electrode 30.

A vacuum, that is, a pressure lower than the ambient air pressure, is maintained in the space between the front panel 1 and the electron emission device 2, and a spacer 60 is placed between the front panel 1 and the electron emission device 2 in order to sustain the pressure generated by the vacuum between the front panel 1 and the electron emission device 2 and to secure a light-emitting space 103.

In the above-described electron emission type backlight unit 3, electrons are emitted from one of the electron emission layers 40 and 50, that is, from the electron emission layer 40 that is formed at the cathode electrode 20 by an electric field generated between the gate electrode 30 and the cathode electrode 20. The emitted electrons travel toward the gate electrode 30 initially and then are attracted by the strong electric field of the anode electrode 80 and move toward the anode electrode 80.

However, an electric field formed between the anode electrode 80 and the cathode electrode 20 interferes with the electric field formed between the gate electrode 30 and the cathode electrode 20, and thus a diode discharge, that is, electron emission and electron acceleration occurring at the same time due to the electric field of the anode electrode 80, is likely to occur.

In addition, due to the light-emitting characteristic of phosphor materials, during a predetermined period of time in which light is emitted by electrons that are incident on a phosphor material, other incident electrons cannot contribute to light emission. Thus light-emitting efficiency is not improved by increasing incident electrons on the phosphor layer 70 beyond this saturation level, and also electron emission by a high anode voltage is detrimental from an energy efficiency aspect. In other words, electrons must be emitted stably and efficiently by a low gate voltage and at the same time the emitted electrons must be uniformly accelerated by a strong anode voltage. However, when electrons are emitted due to a strong anode voltage, efficient electron emission and light emission become impossible.

Thus an electron emission type backlight unit having a new structure in which an electric field between the anode electrode 80 and the cathode electrode 20 can be blocked is desired.

### SUMMARY OF THE INVENTION

Aspects of the present invention provide an electron emission device and an electron emission type backlight unit having a new structure using the electron emission device in which an electric field between an anode electrode and a cathode electrode is effectively blocked, and electrons are emitted continuously and stably due to a low gate voltage, thereby improving light-emitting uniformity and light-emitting efficiency.

Aspects of the present invention also provide a flat display apparatus employing the electron emission type backlight unit.

According to an aspect of the present invention, there is provided an electron emission device comprising: a base substrate; an insulating layer that is formed on a surface of the base substrate; a cathode electrode formed on the insulating layer; a gate electrode formed on the base substrate, separated from the cathode electrode, and higher, extending farther from the base substrate, than the cathode electrode; and an electron emission layer that is electrically connected to the cathode electrode and disposed to face the gate electrode.

While not required in all aspects, the electron emission layer may be formed on both sides of the cathode electrode.

While not required in all aspects, the gate electrode may be surrounded by an insulating layer.

While not required in all aspects, the cathode electrode may be formed to have a protrusion with a predetermined length and width facing the gate electrode, and the electron emission layer is formed on the protrusion, and a concave may be formed in the gate electrode, corresponding to the shape of the protrusion of the cathode electrode.

While not required in all aspects, the cathode electrode may be formed to have a concave with a predetermined length and width facing the gate electrode, and the electron emission layer is formed in the concave. A protrusion may be formed on the gate electrode, corresponding to the shape of the concave of the cathode electrode.

While not required in all aspects, the cathode electrode may be formed to have a curved surface having a predetermined curvature facing the gate electrode, and the electron emission layer is formed on the curved surface. The curved surface may be convex or concave toward the gate electrode, and the gate electrode may be formed to have a curved surface corresponding to the curved surface formed in the cathode electrode.

While not required in all aspects, plane surfaces of the cathode electrode and the gate electrode may be continuously curved. The electron emission layer may be discontinuously formed on a lateral side of the cathode electrode.

According to an aspect of the invention, the gate electrode may be formed to be closer to the base substrate and the anode electrode than the cathode electrode is to the base substrate and the anode electrode.

While not required in all aspects, the electron emission layer may comprise an electron emission material selected from a carbon type material and a nano type material, wherein the carbon type material is selected from the group consisting of carbon nanotubes, graphite, diamond, and diamond-like carbon, and the nano type material is selected from the group consisting of nanotubes, nanowires, nanorods, and nanoneedles.

According to another aspect of the present invention, there is provided an electron emission type backlight unit comprising: a front substrate comprising an anode electrode and a phosphor layer; a base substrate separated from the front substrate; an insulating layer formed on a surface of the base substrate; a cathode electrode formed on the insulating layer; a gate electrode that is formed on the insulating layer, separated from the cathode electrode, and extending farther from the base substrate than the cathode electrode; an electron emission layer that is formed on a lateral side of the cathode electrode and faces the gate electrode; and a spacer maintaining a distance between the front substrate and the base substrate.

According to another aspect of the present invention, there is provided a flat display device comprising: a backlight unit comprising: a front substrate comprising an anode electrode and a phosphor layer; a base substrate separated from the front substrate; an insulating layer formed on a surface of the base substrate; a cathode electrode formed on the insulating layer; a gate electrode that is formed on the insulating layer, separated from the cathode electrode, and extending farther from the base substrate than the cathode electrode; an electron emission layer formed on a lateral side of the cathode electrode facing the gate electrode; and a spacer maintaining a distance between the front substrate and the base substrate; and a non-emissive display device that is formed in front of the electron emission type backlight unit to control light supplied from the electron emission device to realize an image.

While not required in all aspects, the non-emissive display device may be a liquid display device.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a cross-sectional view of a conventional electron emission type backlight unit;

FIG. 2 is a cross-sectional view of an electron emission device and an electron emission type backlight unit according to an embodiment of the present invention;

FIG. 3 is a cross-sectional view of an electron emission device and an electron emission type backlight unit according to another embodiment of the present invention;

FIG. 4 is a cross-sectional view of the electron emission device of FIG. 3 cut along a line IV-IV, according to an embodiment of the present invention;

FIGS. 5 through 10 are cross-sectional views illustrating electron emission devices according to various embodiments of the present invention;

FIG. 11 is a perspective view of a flat display apparatus according to an embodiment of the present invention;

FIG. 12 is a partial cross-sectional view of the flat display apparatus of FIG. 11 cut along a line XII-XII; and

FIG. 13 is a plan view of an image display device according to an embodiment of the present invention.

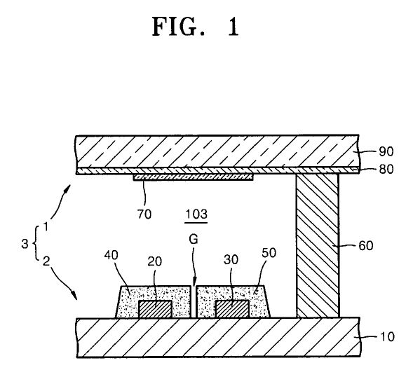

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

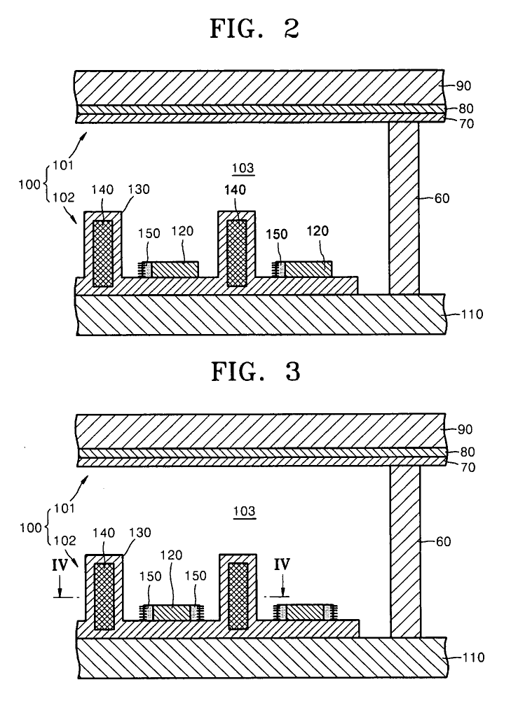

FIG. 2 is a cross-sectional view of an electron emission type backlight unit 100 and an electron emission device 102 according to an embodiment of the present invention.

Referring to FIG. 2, the electron emission type backlight unit 100 includes a front panel 101 and the electron emission device 102 that are separated from and parallel to each other. A vacuum space 103 is formed between the front panel 101 and the electron emission device 102, and a spacer 60 maintains a distance between the front panel 101 and the electron emission device 102.

The front panel 101 includes a front substrate 90, an anode electrode 80 disposed on a lower surface of the front substrate 90, and a phosphor layer 70 disposed on a lower surface of the anode electrode 80.

The electron emission device 102 includes a base substrate 110 disposed at a predetermined interval from and parallel to the front substrate 90 whereby the vacuum space 103 is formed between the front panel 101 and the electron emission device 102, an insulating layer 130 formed on a surface of the base substrate 110, a cathode electrode 120 formed on the insulating layer, a gate electrode 140 that is formed on the insulating layer 130, separated from and parallel to the cathode electrode 120, and is higher than the cathode electrode 120, and an electron emission layer 150 disposed at a side of the cathode electrode 120 to face the gate electrode 140.

The anode electrode 80 applies a high voltage that is necessary to accelerate electrons emitted from the electron emission layer 150 so that the electrons collide with the phosphor layer 70 at a high velocity. The phosphor layer 70 is excited by the electrons and subsequently changes from a high energy level to a low energy level, thus emitting visible light.

While not required in all aspects, the electron emission layer 150 may be disposed entirely on a lateral surface of the cathode electrode 120.

The vacuum space 103 between the front panel 101 and the electron emission device 102 is maintained at a lower pressure than the ambient air pressure, and the spacer 60 is disposed between the front panel 101 and the electron emission device 102 to sustain the vacuum pressure between the front panel 101 and the electron emission device 102 and to partition the vacuum space 103. Generally, the spacer 60 is formed of insulating material such as ceramics or glass that is not electrically conductive. Electrons may be accumulated during the operation of the electron emission type backlight unit 100 on the spacer 60, and to emit these accumulated electrons, the spacer 60 may be coated with a conductive material.

The cathode electrode 120 and the gate electrode 140 form an electric field so that electrons can be easily emitted from the electron emission layer 150. The insulating layer 130 insulates the electron emission layer 150 and the gate electrode 140. The height of the gate electrode 140 is set such that the gate electrode 140 is closer to the base substrate 110 and to the anode electrode 80 than the cathode electrode 120. Thus the electron emission layer 150 is disposed in a more uniform gate electric field. Also, the gate electrode 140 may be surrounded by the insulating layer 130 to prevent a short circuit between the cathode electrode 120 and the gate electrode 140.

Hereinafter, materials of components that constitute the electron emission backlight unit 100 will be described.

While not required in all aspects, the front substrate 90 and the base substrate 110 are board members having a predetermined thickness and may be formed of a quartz glass, a glass including an impurity such as a small amount of Na, a flat glass, a glass substrate coated with SiO₂, an oxide aluminum substrate or a ceramic substrate.

While not required in all aspects, the cathode electrode 120 and the gate electrode 140 may be formed of general electrically conductive materials. Examples of the general electrically conductive materials include a metal (e.g., Al, Ti, Cr, Ni, Au, Ag, Mo, W, Pt, Cu, Sn, Sb, In or Pd) and alloys thereof, a conductive material made of either metal (e.g., Pd, Ag, RuO₂, or Pd—Ag) or its oxide and glass, a transparent conductive material such as indium tin oxide (ITO), In₂O₃ or SnO₂, and a semiconductor material such as polysilicon.

Electron emission materials that are formed in the electron emission layer 150 and emit electrons due to an electric field may be any electron emission material that has a small work function and a high β function. Specifically, carbon type materials such as carbon nanotubes (CNT), graphite, diamond and diamond-like carbon or nano materials such as nanotubes, nano wires, nanorods, or nanoneedles are preferable. CNTs particularly have good electron emission properties and can be driven at a low voltage. Therefore devices using CNTs as an electron emission layer can be applied to a larger electron emission display device.

According to an aspect of the present invention, the electron emission type backlight unit 100 operates as follows.

A negative voltage is applied to the cathode electrode 120 and a positive voltage is applied to the gate electrode 140 so that electrons can be emitted from the electron emission layer 150 formed on the cathode electrode 120. Also, a strong positive voltage is applied to the anode electrode 80 to accelerate the electrons emitted toward the anode electrode 80. Thus electrons are emitted from electron emission materials that form the electron emission layer 150 and travel toward the gate electrode 140 and then are accelerated toward the anode electrode 80. The electrons accelerated toward the anode electrode 80 collide with the phosphor layer 70 formed on the anode electrode 80 and thus generate visible light.

Since the gate electrode 140 is formed to be higher than the cathode electrode 140, the electric field formed by the anode electrode 80 can be prevented from interfering with the electric field between the cathode electrode 120 and the gate electrode 140. Thus, it is easy to control the anode electrode 80 and the gate electrode 140 such that the anode electrode 80 only accelerates the electrons and the gate electrode 140 emits the electrons, thereby maximizing the light-emitting uniformity and the light-emitting efficiency of the phosphors and preventing diode discharge.

Hereinafter, other example embodiments of the electron emission device 102 illustrated in FIG. 2 will be described.

FIG. 3 is a cross-sectional view illustrating another example embodiment of the electron emission device 102 of FIG. 2.

As illustrated in FIG. 3, an electron emission layer 150 is disposed on both sides of a cathode electrode 120 such that gate electrodes 140 disposed on both sides of the cathode electrode 120 and their respective electric fields can emit electrons. Thus, space is reduced and more electrons can be emitted at the same time.

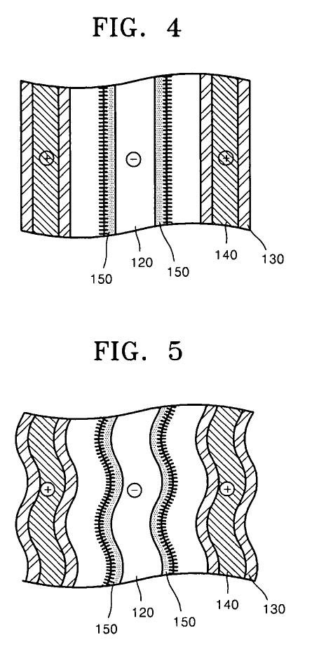

FIG. 4 is a cross-sectional view of the electron emission device 102 of FIG. 3 cut along a line IV-IV. FIGS. 5 through 10 are cross-sectional views illustrating electron emission devices according to various embodiments of the present invention.

Referring to FIG. 4, the cathode electrode 120 and the gate electrode 140, while not required in all aspects, are arranged in a striped pattern and are parallel to each other. Also, as illustrated in FIGS. 5 through 10, the various forms of the cathode electrode 120, the gate electrode 140 and of the electron emission layer 150 may be numerous.

As illustrated in FIG. 5, the plane surface of the cathode electrode 120 and the gate electrode 140 may have a continuously curved surface. While not required in all aspects, the continuously curved surface has a repetitively changing curvature. With a continuously curved surface, the surface area on which the electron emission layer 150 is formed can be greatly increased along the entire length of the electrodes, thereby significantly increasing the current density.

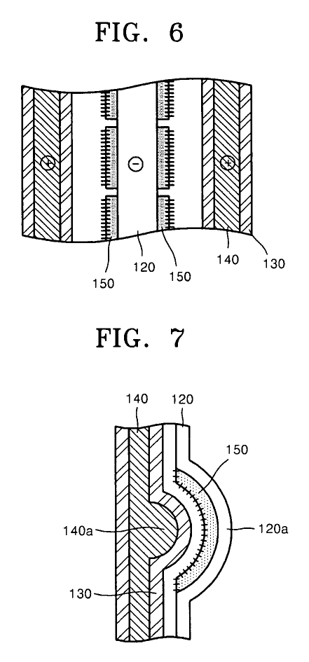

Also, as illustrated in FIG. 6, the electron emission layer 150 may be discontinuously formed at one side or at both sides of the cathode electrode 120. The location of the phosphor layer 70 normally disposed to receive electrons emitted from a continuous emission layer 150, may be partially limited by the location of the spacer 60 or the position of a structure for fixing the spacer 60, and when the electron emission layer 150 is formed in these areas, the electron emission layer 150 cannot contribute to the emission of visible light.

Furthermore, as the current density increases, the amount of the generated visible light increases due to the characteristic of CL type phosphors, but at a predetermined saturated current density, the intensity of the visible light generated does not increase any more. Accordingly, forming as many electron emission layers as possible is not always efficient, and thus it may be preferable to discontinuously form an electron emission layer to secure an appropriate surface area of the electron emission layer.

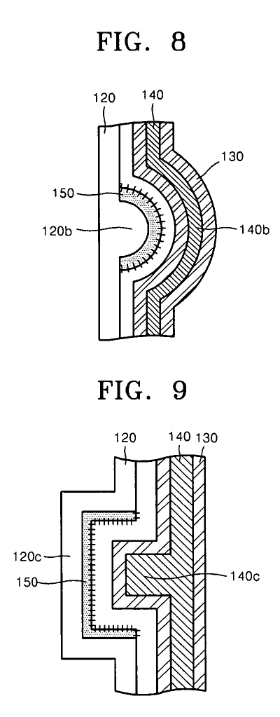

As illustrated in FIGS. 7 and 8, the cathode electrode 120 may include curved surfaces 120a and 120b, and the electron emission layer 150 may be formed on the curved surfaces 120a and 120b. While not required in all aspects, the curved surfaces 120a and 120b may be concave (120a, see FIG. 7) or convex (120b, see FIG. 8) in relation to the gate electrode 140. In this case, curved surfaces 140a and 140b respectively corresponding to the curved surfaces 120a and 120b are formed in the gate electrode 140.

Also, as illustrated in FIG. 9, the cathode electrode 120 includes a concave 120c having a predetermined length and width toward the gate electrode 140 and an electron emission layer 150 may be disposed in the concave 120c. In this case, a protrusion 140c corresponding to the shape of the concave 120c is formed in the gate electrode 140.

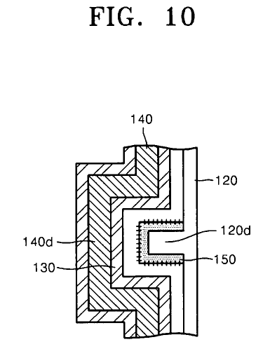

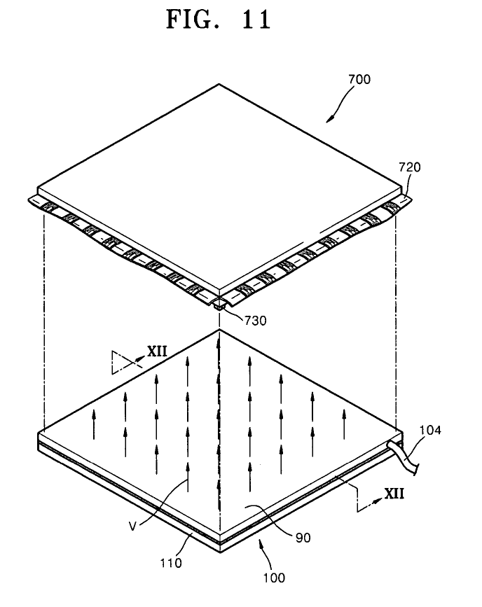

Also, as illustrated in FIG. 10, the cathode electrode 120 may include a protrusion 120d having a predetermined length and width toward the gate electrode 140 and an electron emission layer 150 may be disposed on the protrusion 120d. In this case, a concave 140d corresponding to the protrusion 120d is formed in the gate electrode 140.

The shape of the protrusions formed in the cathode electrode 120 and the gate electrode 140 is not limited to a rectanglular shape as illustrated in FIGS. 9 and 10, but may also be a trapezoidal or other polygonal shape.

According to an aspect of the invention, the electron emission backlight unit 100 having the above-described configurations may be used as a back light unit (BLU) of a non-emissive display device such as a liquid crystal display (LCD), and in this case, the cathode electrode 120 and the gate electrode 140 are disposed substantially parallel to each other. Also, the phosphor layer 70 may include phosphors emitting visible light with a desired color, or red, green, and blue light emitting phosphors at an appropriate rate to obtain white light.

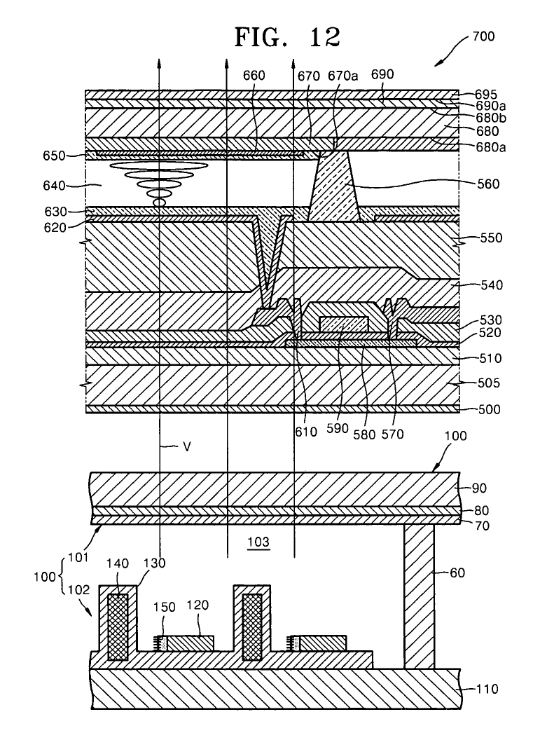

FIG. 11 is a perspective view of a flat display apparatus including an electron emission type backlight unit according to an embodiment of the present invention. FIG. 12 is a partial cross-sectional view of the flat display apparatus of FIG. 11 cut along a line XII-XII.

Referring to FIG. 11, the flat display apparatus according to the present embodiment is a non-emissive device and includes a liquid crystal display (LCD) device 700 and an electron emission type backlight unit 100 that supplies visible light to the LCD device 700. A soft printed circuit board 720 transmitting image signals is attached to the LCD device 700, and a spacer 730 is disposed to maintain a distance between the LCD device 700 and the back light unit 100 that is disposed at the back of the LCD device 700.

The electron emission type backlight unit 100 receives power supplied via a connection cable 104 and emits visible light V through a front panel 90 disposed in front of the electron emission device, thereby supplying visible light V toward the LCD device 700.

The structure and operation of the LCD device 700 will be described hereinafter with reference to FIG. 12.

The electron emission type backlight unit 100 illustrated in FIG. 12 may include one of the electron emission devices described above. As illustrated in FIG. 12, the electron emission backlight unit 100 is formed as a single unit including a front panel 101 and an electron emission device 102 that are separated from each other. The structures of the front panel 101 and the electron emission device 102 are the same as described before and thus will not be repeated. Electrons are emitted by an electric field formed by a cathode electrode 120 and a gate electrode 140 formed in the electron emission device 102. The electrons are accelerated by an electric field formed by the anode electrode 80 installed in the front panel 101 and visible light V is generated by the collision of the electrons with the phosphor layer 70. The generated visible light V proceeds towards the LCD device 700.

Meanwhile, the LCD device 700 includes a front panel 505, and a buffer layer 510 is formed on the front panel 505, and a semiconductor layer 580 is formed on the buffer layer 510 in a predetermined pattern. A first insulating layer 520 is formed on the semiconductor layer 580, a gate electrode 590 is formed in a predetermined pattern on the first insulating layer 520, and a second insulating layer 530 is formed on the gate electrode 590. After the second insulating layer 530 is formed, the first and second insulating layers 520 and 530 are etched using a dry etching method or other similar process and thus a portion of the semiconductor layer 580 is exposed, and a source electrode 570 and a drain electrode 610 are formed in a predetermined area including the exposed portion of the semiconductor layer 580. After the source electrode 570 and the drain electrode 610 are formed, a third insulating layer 540 is formed, and a planarization layer 550 is formed on the third insulating layer 540. A first electrode 620 is formed on the planarization layer 550 in a predetermined pattern, and a portion of the third insulating layer 540 and the planarization layer 550 is etched, and thus a conductive path between the drain electrode 610 and the first electrode 620 is formed. A transparent base substrate 680 is separated from the front panel 505, and a color filter layer 670 is formed on a lower surface 680a of the base substrate 680. A second electrode 660 is formed on a lower surface 670a of the color filter layer 670, and a first alignment layer 630 and a second alignment layer 650 that align a liquid crystal layer 640 are formed in the area where the surfaces of the first electrode 620 and the second electrode 660 face each other. A first polarization layer 500 is formed on a lower surface of the front panel 505, a second polarization layer 690 is formed on a upper surface 680b of the base substrate 680, and a protection film 695 is formed on a upper surface 690a of the second polarization layer 690. A spacer 560 that partitions the liquid crystal layer 640 is formed between the color filter layer 670 and the planarization layer 550.

The LCD device 700 operates as follows. A potential difference is formed between the first and second electrodes 620 and 660 due to an external signal controlled by the gate electrode 590, the source electrode 570, and the drain electrode 610, and the liquid crystal layer 640 is aligned by the potential difference, and the visible light V supplied from the backlight unit 100 is shielded or transmitted according to the alignment of the liquid crystal layer 640. The transmitting light passes the color filter layer 670 and is colored to realize an image.

According to the current embodiment of the present invention, illustrated in FIG. 12, a liquid crystal display device such as a thin film transistor liquid crystal display (TFT-LCD) is used, but the non-emissive display device forming a flat display apparatus according to the present invention is not limited thereto. Also, the non-emissive display device may be other devices besides a liquid crystal display device.

A flat display apparatus including the above described electron emission device and the electron emission type backlight unit includes a backlight unit with increased brightness and life span, and thus the brightness of the image and life span of the display apparatus can also be increased.

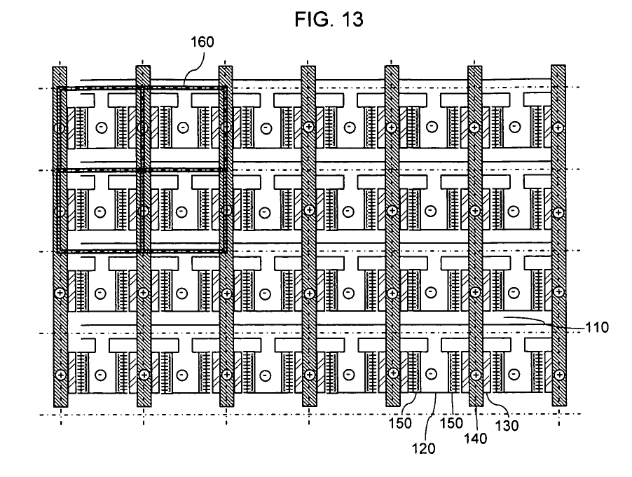

According to an embodiment of the present invention, the electron emission device having the above-described configuration can be used as an image display device. In this case, the electron emission device may have a structure in which the gate electrode 140 and the cathode electrode 120 are formed in strips and cross each other, which is advantageous for applying signals to realize an image. For example, when the cathode electrode 120 is formed in strips extending in one direction, the gate electrode 140 may be formed of a main electrode crossing the cathode electrode 120 and a branch electrode extending from the main electrode to face the cathode electrode 120. The arrangement of the cathode electrode 120 and the gate electrode 140 may be exchanged as shown in FIG. 13. When a color display device is realized, red, green, and blue light-emitting phosphors are formed in the vacuum space 103 forming a unit pixel 160 under the anode electrode 80.

As described above, according to an aspect of the present invention, an upper end of the gate electrode 140 is disposed closer to the anode electrode 80 than the cathode electrode is to the anode electrode 80 such that an electric field of the anode electrode 80 is prevented from interfering with the electric field between the cathode electrode 120 and the gate electrode 140. Thus electron emission and acceleration becomes easy to control such that the anode electrode 80 only accelerates the electrons and the electrons are emitted from the gate electrode 140, thereby obtaining light-emitting uniformity and maximizing the light-emitting efficiency of the phosphors. Also, the electron emission device can be manufactured by a simple process.

Also, since a lower end of the gate electrode 140 is closer to the base substrate 680 than the cathode electrode 120 according to an aspect of the present invention, the electron emission layer 150 is located in a more uniform electric field and uniform electron emission can occur in the electron emission layer 150.

Also, curved surfaces, protrusions, or grooves are formed in the cathode electrode 120 and the gate electrode 140, which are formed in strips according to an aspect of the present invention, and thus the surface area of the electron emission layer 150 is increased, thereby increasing the electron emitting efficiency.

Meanwhile, when a backlight unit is formed using an electron emission device according to aspects of the present invention, a display apparatus employing the backlight unit can have improved brightness and light-emitting efficiency.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An electron emission device comprising:
a base substrate;
an insulating layer formed on a surface of the base substrate;
a cathode electrode formed on the insulating layer;
a gate electrode formed on the base substrate, separated from the cathode electrode, and higher than the cathode electrode; and
an electron emission layer electrically connected to the cathode electrode and disposed to face the gate electrode.

2. The electron emission device of claim 1, wherein the cathode electrode and the gate electrode are plural in number and alternately arranged.

3. The electron emission device of claim 1, wherein the electron emission layer is formed on both sides of the cathode electrode.

4. The electron emission device of claim 1, wherein the gate electrode is surrounded by an insulating layer.

5. The electron emission device of claim 1, wherein the cathode electrode and the gate electrode are arranged in a striped pattern and are parallel to each other.

6. The electron emission device of claim 1, wherein the cathode electrode and the gate electrode are arranged in a striped pattern and cross each other, the cathode electrode having a first branch electrode extending to face the gate electrode, the gate electrode having a second branch electrode extending to face the cathode electrode, or the cathode electrode first branch extending to face the gate electrode second branch.

7. The electron emission device of claim 1, wherein the cathode electrode has a protrusion with a predetermined length and width facing the gate electrode, and the electron emission layer is formed on the protrusion.

8. The electron emission device of claim 7, wherein a concave is formed in the gate electrode, corresponding to the shape of the protrusion of the cathode electrode.

9. The electron emission device of claim 7, wherein the protrusion has a polygonal shape.

10. The electron emission device of claim 1, wherein the cathode electrode has a concave with a predetermined length and width facing the gate electrode, and the electron emission layer is formed in the concave.

11. The electron emission device of claim 10, wherein a protrusion is formed on the gate electrode, corresponding to the shape of the concave of the cathode electrode.

12. The electron emission device of claim 10, wherein the concave has a polygonal shape.

13. The electron emission device of claim 1, wherein the cathode electrode has a curved surface having a predetermined curvature facing the gate electrode, and the electron emission layer is formed on the curved surface.

14. The electron emission device of claim 13, wherein the curved surface is convex toward the gate electrode.

15. The electron emission device of claim 13, wherein the curved surface is concave toward the gate electrode.

16. The electron emission device of claim 13, wherein the gate electrode has a curved surface corresponding to the curved surface formed in the cathode electrode.

17. The electron emission device of claim 1, wherein plane surfaces of the cathode electrode and the gate electrode are continuously curved.

18. The electron emission device of claim 17, wherein the continuously curved surfaces are repetitively changing curvature and the electron emission layer is arranged on the continuously curved surface of the cathode electrode.

19. The electron emission device of claim 1, wherein the electron emission layer is discontinuously formed on a lateral side of the cathode electrode.

20. The electron emission device of claim 1, further comprising:
an anode electrode; wherein the gate electrode is closer to the base substrate and the anode electrode than the cathode electrode is to the base substrate and the anode electrode.

21. The electron emission device of claim 1, wherein the electron emission layer comprises an electron emission material selected from a carbon type material and a nano type material, wherein the carbon type material is selected from the group consisting of carbon nanotubes, graphite, diamond, and diamond-like carbon, and the nano type material is selected from the group consisting of nanotubes, nanowires, nanorods, and nanoneedles.

22. The electron emission device of claim 1, wherein the cathode electrode and the gate electrode are electrically conductive materials.

23. An electron emission type backlight unit comprising:
a front substrate comprising an anode electrode and a phosphor layer;
a base substrate separated from the front substrate;
an insulating layer formed on a surface of the base substrate;
a cathode electrode formed on the insulating layer;
a gate electrode formed on the insulating layer, separated from the cathode electrode, and higher than the cathode electrode;
an electron emission layer that is formed on a lateral side of the cathode electrode and faces the gate electrode; and
a spacer to maintain a distance between the front substrate and the base substrate.

24. The electron emission type backlight unit of claim 23, wherein the cathode electrode and the gate electrode are arranged in a striped pattern and are parallel to each other.

25. The electron emission type backlight unit of claim 23, wherein the cathode electrode and the gate electrode are arranged in a striped pattern and cross each other, wherein:
the cathode electrode has a first branch electrode extending to face the gate electrode;
the gate electrode has the first branch electrode extending to face the cathode electrode; or
the cathode electrode has the first branch electrode and the gate electrode has a second branch electrode extending to face the first branch electrode of the cathode electrode.

26. The electron emission type backlight unit of claim 23, wherein the phosphor layer is red, green, and blue light-emitting to form a unit pixel.

27. The electron emission type backlight unit of claim 23, wherein the gate electrode is formed to be closer to the base substrate and the anode electrode than the cathode electrode is to the base substrate and the anode electrode.

28. The electron emission type backlight unit of claim 23, wherein the spacer is coated with a conductive material.

29. A flat display device comprising:
a backlight unit comprising:
a front substrate comprising an anode electrode and a phosphor layer,
a base substrate separated from the front substrate,
an insulating layer formed on a surface of the base substrate,
a cathode electrode formed on the insulating layer,
a gate electrode formed on the insulating layer, separated from the cathode electrode, and higher than the cathode electrode,
an electron emission layer formed on a lateral side of the cathode electrode facing the gate electrode, and
a spacer to maintain a distance between the front substrate and the base substrate; and
a non-emissive display device that is formed in front of the electron emission type backlight unit and controls light supplied from the electron emission device to realize an image.

30. The flat display device of claim 29, wherein the non-emissive display device comprises:
a front panel;
a buffer layer formed on the front panel;
a semiconductor layer formed on the buffer layer in a predetermined pattern;
a first display device insulating layer formed on the semiconductor layer;
a display device gate electrode formed in a predetermined pattern on the first display device insulating layer;
a second display device insulating layer formed on the display device gate electrode;
a source electrode formed on a predetermined area of the second display device insulating layer including an etched area of the first and second display device insulating layers where a portion of the semiconductor layer is exposed;
a drain electrode formed on another predetermined area of the second display device insulating layer including another etched area of the first and second display device insulating layers where another portion of the semiconductor layer is exposed;
a third display device insulating layer formed on the source electrode, the drain electrode, and the second display device insulating layer;
a planarization layer formed on the third display device insulating layer;
a first electrode formed on the planarization layer in a predetermined pattern, wherein a portion of the third display device insulating layer and the planarization layer is etched to create a conductive path between the drain electrode and the first electrode;
a transparent base substrate separated from the front panel;
a color filter layer formed on a first surface of the transparent base substrate;
a second electrode formed on a surface of the color filter layer opposite the transparent base substrate;
a liquid crystal layer;
a first alignment layer and a second alignment layer to align the liquid crystal layer, wherein the first alignment layer is formed on a surface of the first electrode opposite the planarization layer and the second alignment layer is formed on a surface of the second electrode opposite the color filter layer and on the surface of the color filter layer opposite the transparent base substrate not covered by the second electrode;
a first polarization layer formed on a surface of the front panel opposite the buffer layer;
a second polarization layer formed on a second surface of the transparent base substrate opposite the color filter layer;
a protection film formed on a surface of the second polarization layer opposite the transparent base substrate; and
a display device spacer formed between the color filter layer and the planarization layer to partition the liquid crystal layer.

31. The flat display device of claim 29, wherein the non-emissive display device is a liquid display device.

32. An electron emission type backlight unit comprising:
a first substrate comprising an anode electrode and a phosphor layer;
a base substrate separated from the first substrate;
a cathode electrode arranged on the base substrate;
a gate electrode arranged on the base substrate, separated from the cathode electrode;
an electron emission layer that is formed on a side of the cathode electrode and faces the gate electrode; and
a spacer to maintain a distance between the first substrate and the base substrate, wherein the cathode electrode and the gate electrode are arranged to shield the cathode electrode from the anode electrode.

33. The electron emission type backlight unit of claim 32, wherein the gate electrode is formed to be closer to the anode electrode than the cathode electrode is to the anode electrode.

34. The electron emission type backlight unit of claim 33, further comprising an insulating layer between the cathode electrode and the base substrate, wherein the gate electrode is formed to be closer to the base substrate than the cathode electrode is to the base substrate.
